(19) United States
(12) Patent Application Publication
(10) Pub. No.: US 2010/0229657 A1
(43) Pub. Date: Sep. 16, 2010

(54) Sinter-bonded metal flow restrictor for regulating volumetric gas flow through an aerosol sampler inlet

(76) Inventor: Jason P. Weinstein, Holly Springs, NC (US)

Correspondence Address: MICHAEL N. LAU;LAU & ASSOCIATES, LLC, 2121 EISENHOWER AVENUE, SUITE 200, ALEXANDRIA, VA, 22314, US

(21) Appl. No.: 12/382,291

(22) Filed: Mar. 12, 2009

(51) Int. Cl. G01N 1/22

(52) U.S. Cl. 73/863.22; 73/863.23

(57) ABSTRACT

The present invention allows for increased volumetric flow rates relative to current commercially available technology in battery-powered PM sampling devices while vastly simplifying the operation of that device. This will allow for the capture of more PM in a shorter amount of time by allowing a shorter sampling duration and finer scale sampling or the collection of meaningful levels of PM in areas with unusually low concentrations of pollution. Further, the invention can be applied to any aerosol sampling device which requires a fixed rate of volumetric gas flow drawn through an aerosol sampling inlet.

### BACKGROUND

Commercially manufactured air pollution sampling instruments are used to collect airborne particulate matter (PM). There are two basic configurations for air pollution sampling devices, first, mobile pollution sampling instruments and second, stationary pollution sampling instruments. Mobile sampling devices are worn on the body to test human exposure to PM, stationary pollution sampling devices capture PM at a fixed site for a pre-determined sampling duration. Each air pollution sampling device manufacturer approaches the regulation of volumetric flow differently. The following are some of the different technical approaches.

Electronic mass flow control (MFC's) devices as exemplified by U.S. Pat. Nos. 7,231,931, 6,631,334, 5,850,850, 4,389,903 are used to regulate volumetric flow in the laboratory environment where environmental conditions are carefully controlled to ensure device stability and performance consistency. A chief disadvantage for regulating volumetric flow in the real-world field environment is that MFC's perform poorly when input sample temperatures change rapidly, such change is not uncommon due to continually evolving weather. MFC's have the added disadvantages of 1) requiring a DC or AC power source; 2) requiring extra sampling line plumbing due to their relatively large sizes; 3) requiring frequent adjustment to reach a desired set point; and 4) requiring a 20 minute warm-up time before actual testing, even in the controlled laboratory environment.

Needle valve flow meters as exemplified by U.S. Pat. Nos. 5,507,190 and 4,134,572 can be used to regulate volumetric flow. Chief disadvantages for regulating volumetric flow with needle valve flowmeters include 1) an unacceptable inaccuracy ranging from −25% to +25% variance in flow; 2) a high degree of difficulty in adjusting to a desired set point; 3) a poor performance under varying environmental conditions caused by changes in ambient temperature, pressure, and humidity; and 4) an unduly large physical size which requires extra instrument case space and extra sampling line plumbing.

Calibrated limiting flow orifices as exemplified by a Millipore limiting orifice set, orifice device of U.S. Pat. No. 4,098,850 can be used to regulate volumetric flow. A chief disadvantage for regulating volumetric flow is the calibrated limiting orifice consist of one single opening. This design leaves the limiting orifice highly susceptible to contamination because one small particle contaminant can drastically alter the resultant volumetric flow. These devices are best suited for use in clean air environments in a laboratory setting. They perform poorly in the real world environment where there are varying PM sizes and where the ambient temperature, pressure, and humidity can change dramatically.

Critical flow venturi as exemplified by U.S. Pat. No. 4,649,760 can be used to regulate volumetric flow. A chief disadvantage for regulating volumetric flow is the critical flow venturi is physically large and cannot be incorporated into portable instruments. It requires a relatively high vacuum to achieve a critical flow, in turn, this requires a substantial amount of operating current to power the associated vacuum pump thus not energy efficient especially for a battery operated device. This technology is not suitable for use in field portable sampling devices.

Current limiting direct flow control as exemplified by U.S. Pat. No. 6,741,056 is used to regulate volumetric flow in low-flow battery-powered sampling devices. In these devices, the flow adjustment is achieved by electronically adjusting the vacuum pump motor speed. Chief disadvantages for regulating volumetric flow are the current limiting direct flow control exhibits a significant amount of electronic drift under varying temperature, pressure, and humidity changes. The electronic drift adversely affects the resultant volumetric flow and the change in volumetric flow can exceed the flow tolerance levels required by aerosol sampling devices. Current limiting direct flow control devices require associated electronic components to control volumetric flow. The electronic components require extra operating power above and beyond that required by a vacuum pump. The electronic components 1) add to the complexity and physical size of the device; 2) require frequent calibration to ensure accurate operation; and 3) are susceptible to failures caused by static discharge, physical impacts, lightning strikes, and short circuits caused by water, salt water, etc. The risk of these failures is sometimes inevitable during actual field use.

Multiple air intake electronic flow control as exemplified by U.S. Pat. Nos. 6,138,521 and 5,553,507 is used to regulate volumetric flow in Federal Reference Method (FRM) PM sampling instruments. This system is very accurate and precise in regulating volumetric flow drawn through PM sampler inlets. Chief disadvantages for regulating volumetric flow are the electronic flow control 1) requires highly complex electronic components and sensors; 2) is very expensive; 3) is physically large and therefore not suited for miniaturization; 4) requires AC power to operate; 5) requires frequent calibration; and 6) requires a significant amount of operator expertise to operate.

No commercial manufacturer has used sinter-bonded metal (SBM) flow restrictors in conjunction with compact vacuum pump technologies to regulate volumetric flow drawn through aerosol collection and analysis devices. The present invention will therefore allow EPA, other governmental agencies, and public entities to accurately and simply regulate volumetric air flow in air pollution sampling devices, or any other aerosol sampling device requiring a fixed rate, constant volume of gas drawn through a sample line or sample inlet.

### SUMMARY OF THE INVENTION

The first object of the present invention is to provide a sampling device that is simple to operate without the need for calibration or adjustment prior to each use.

The second object of the present invention is to regulate volumetric gas flow accurately and precisely so that the resulting volumetric gas flow is virtually identical every time it is used.

The third object of the present invention is to provide a sampling device that is easy to use and requires nearly no operator skills to operate.

The fourth object of the present invention is to provide a sampling device that is relatively insensitive to changes in the operating environment so that it can reliably operate in a wide range of temperature, pressure, and humidity levels.

The fifth object of the present invention is to provide a sampling device that is chemically inert so that it can operate effectively in a diverse set of corrosive environments.

The sixth object of the present invention is to provide a sampling device that is physically small and very light-weight so that it can be incorporated into instruments that are truly portable.

The seventh object of the present invention is to provide a sampling device that is nearly service-free and requires infrequent disassembly and ultrasonic cleaning to restore to proper operating parameters.

The eighth object of the present invention is to provide a sampling device with a theoretically infinite useful life with no moving parts and no wear components other than the vacuum pump and filter related parts.

The ninth object of the present invention is to provide an inexpensive sampling device compared to currently existing technologies that regulate volumetric gas flow in field instruments.

The tenth object of the present invention is to provide a sampling device with 1% to 5% variance in flow rate under fixed sampling conditions.

The eleventh object of the present invention is to provide a sampling device requiring a low power vacuum pump due to a low pressure drop requirement.

### DRAWINGS OF INVENTION

FIG. 1 shows a first representative embodiment of the present invention.

FIG. 2 shows a second representative embodiment of the present invention.

FIG. 3 shows a detailed specification of the second representative embodiment of the present invention.

FIG. 4 shows a pictorial illustration of the operation of an inertial impactor.

FIG. 5 shows a perspective view of an exterior housing of a sinter-bonded metal flow restrictor.

FIG. 6 shows a perspective view of a sinter-bonded metal flow restrictor.

FIG. 7 shows a graph illustrating relationships between a sinter-bonded metal restrictor flow versus pressure differential.

### DESCRIPTION OF THE INVENTION

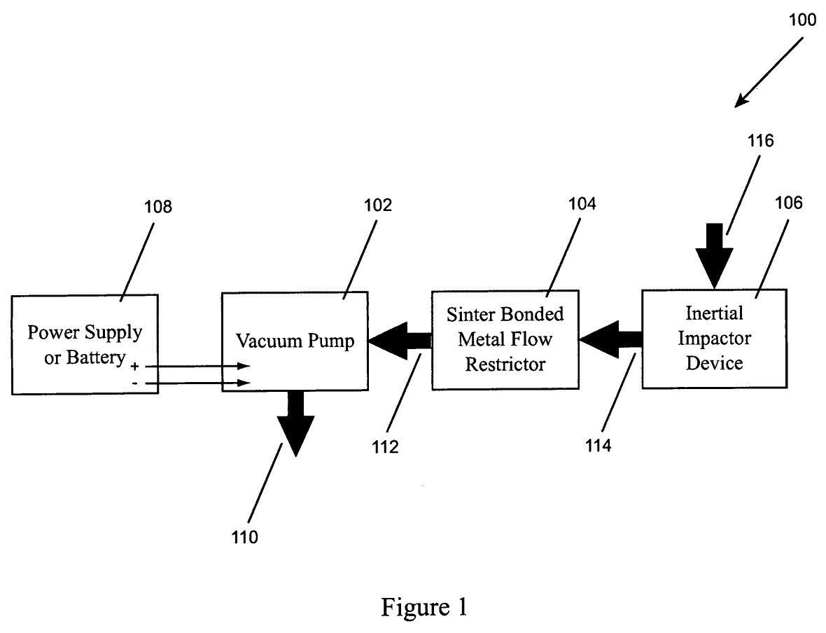

FIG. 1 is a first representative embodiment of the present invention. As shown in the sample collection apparatus 100, the vacuum pump 102, sinter-bonded metal flow restrictor 104 and the inertial impactor device 106 are pneumatically interconnected. The vacuum pump 102 is electrically connected to a power supply or a battery 108. The power supply or battery 108 supplies energy to the vacuum pump 102 to generate a negative pressure whereby fluid/air exits the vacuum pump 102 via airway 110 into the ambient environment. By virtue of the same negative pressure, fluid/air from the ambient environment is suctioned into the vacuum pump 102 via airway 116, the inertial impactor device 106, airway 114, the sinter-bonded metal flow restrictor 104 and airway 112. The sinter-bonded metal flow restrictor 104 is strategically placed downstream from the inertial impactor device 106 and upstream from the vacuum pump 102 to precisely regulate flow to impactor device 106 and to ensure long term stability and operational longevity of the sample collection apparatus 100. As both the inertial impactor device 106 and the sinter-bonded metal flow restrictor 104 are passive devices, and throughput is solely generated by the only active device which is the vacuum pump 102, the exact placement of the sinter-bonded metal flow restrictor 104 is of critical importance. Had the sinter-bonded metal flow restrictor 104 been placed downstream of the vacuum pump 110 which is further downstream of the inertial impactor device 106, the restrictor 104 being the most effective throughput control device is placed too far downstream from the inertial impactor device 106 which would adversely affect the working effectiveness and efficiency of the inertial impactor device 106 upstream. On the other hand, had the sinter-bonded metal flow restrictor 104 been placed upstream of the inertial impactor device 106, the restrictor 104 would be easily clogged by environmental particulate matters as well as blocking particulate matter from reaching the inertial impactor device 106 defeating the sample collection purpose of the present invention. It is only when the sinter-bonded metal flow restrictor 104 is placed between the inertial impactor device 106 and the vacuum pump 102 that optimum and collective performance of the sample collection apparatus 100 can be obtained because the restrictor 104 is able to achieve the overall throughput control objective yet the very controller of throughput consistency is directly connected to the inertial impactor device 106 to ensure best performance possible.

The present invention is used to regulate the volumetric gas flow drawn through any aerosol sampling device requiring a fixed rate of a specific gas passing through a sample line and/or sample inlet. The intended application is the regulation of volumetric air flow in pollution sampling devices that use particulate matter (PM, PM2.5, PM10) inertial impactors as exemplified by U.S. Patent Application No. 20070044577 and U.S. Pat. Nos. 7,073,402, 6,786,105 and 4,827,779. Specifications associated with the patent related literatures are incorporated herein by reference. In the field of particulate matter, PM means particulate matter, PM2.5 means particulate matter 2.5 microns or smaller and PM10 means particulate matter 10 microns or smaller. In sampling PM, inertial impactor based collection methods are used for personal sampling devices and to a lesser extent ambient air monitoring devices. The key to portable sampling devices is precise volumetric flow control, small form factor, battery power, light weight, ease of use, and simplicity. The present invention meets all of the aforementioned criteria for regulating volumetric gas flow drawn through any aerosol sampling device.

The present invention involves the application of a custom made sinter-bonded metal (SBM) restrictor 104 manufactured by one of a very small pool of porous metal manufacturers around the world, for example, Chand Eisenmann Metallurgical, Mott Corporation (Model 300 Series), GKN Sinter Metals Filters (Model SIKA-IS, SIKA-R . . . AX, SIKA-FIL, SIKA-R . . . AS, SIKA-BX), Applied Porous Technologies Inc., SSI Technologies Inc. Specification of these products is incorporated herein by reference. The present invention can be used more generically to regulate volumetric gas flow at the inlet of any aerosol sampling device that requires 1) a low pressure drop vacuum pump configuration for regulating volumetric gas flow, 2) simplicity of operation, 3) no need for calibration, 4) physically small size and light weight, 5) stringent gas flow requirements for gases drawn through a sample line or sample inlet, and 6) energy efficiency.

The present invention relies on a negative flow known as vacuum drawn through a custom designed SBM restrictor 104 to produce a fixed rate volumetric gas flow at the inlet of any aerosol sampling device which is connected to the SBM restrictor 104 by hollow tubing or a series of hollow fittings. The SBM restrictor 104 is custom designed to meet a specified set of conditions for regulating volumetric flow rate. The specification of the device is based on considerations of the outlet flow rate supplied by a vacuum 102 and desired inlet flow rate of the aerosol sampler. The custom designed SBM restrictor is optimized through the choice of metal powder type, size of particles comprising the metal powder, and the physical arrangement of the vessel containing the pressed metal powder. The present invention is most effective when the flow restriction device operates in a relatively low pressure drop configuration. Specifically, the free flowing vacuum source flow rate at the outlet of the SBM restrictor 104 is 20-50% greater than the resultant flow at the inlet of SBM restrictor 104.

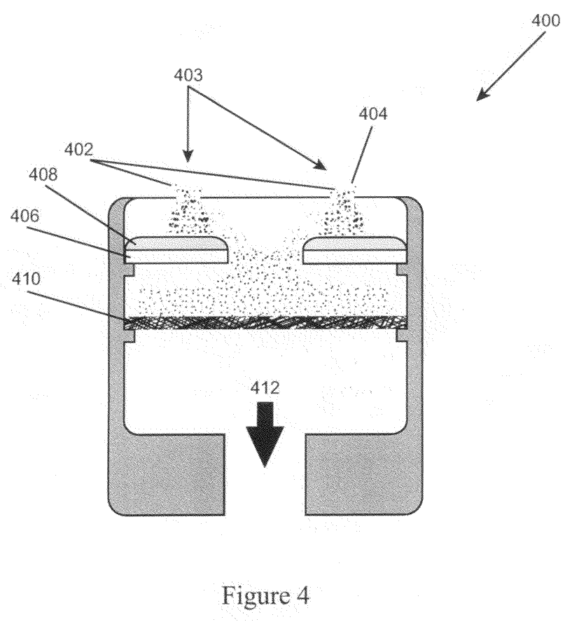

FIG. 4 shows an example illustrating the operation of an inertial impactor 400. Inertial impactor 400 based aerosol samplers require a fixed flow rate of ambient air containing an air stream of PM 404 passing through a set of nozzles 402 which impinge upon one or more collection plate(s) 406 coated with a layer of viscous material 408. Arrow 403 shows entry direction of an ambient air stream. PM 404 in the flow stream having a large enough inertia will impact upon the collection plate 406 and be adhered by the layer of viscous material 408 while other particles with smaller inertia will follow the airflow via airways out of the impaction region into a filter 410 thereby becoming trapped thereto. Of course, depending on the size of the PM designed to be trapped by filter 410 and the remainder of PM trapped by viscous material 408, the diameter and flow profile of the nozzles 402 and distance between viscous material 408 and nozzles 402 is calculated in view of the volumetric flow rate. Arrow 412 shows the exit direction of the air stream. Small PM entrapped by the filter 410 and large PM adhered onto the layer of viscous material 408 are samples for analysis depending upon the study of interest.

The principle application of the present invention involves placing a custom-designed SBM restrictor in-line between a linear drive vacuum pump such as that disclosed by U.S. Patent Application No. 20060034707 (downstream) and an inertial impactor (upstream) in order to regulate volumetric air flow drawn through the inlet(s) of the inertial impactor. The specification of the U.S. Patent Application No. 20060034707 is incorporated herein by reference. The present invention vastly simplifies the regulation of volumetric flow control, is physically small as the sinter-bonded metal is encapsulated in a cylinder 0.25″ in diameter and 0.25″ in height, and is chemically inert.

Porous powdered metal (P/M) flow restrictors are used to provide a constant gas flow for a given set of pressure, temperature, and fluid conditions, as exemplified by U.S. Pat. No. 6,802,333. The specification of U.S. Pat. No. 6,802,333 is incorporated herein by reference. P/M flow restrictors are passive devices. They have no moving parts, no electrical components, and do not require calibration after manufacture. P/M flow restrictors are manufactured by pressing a specific metal powder at high pressure in a sample cup, for example as disclosed in U.S. Pat. Nos. 5,149,360, 4,828,930, 4,822,692, 4,613,369, 4,225,346 and 2,792,302. Specifications of these patents are incorporated herein by reference. The pressed powder cup is then heated at a high temperature to melt grain boundaries and produce a particulate material matrix with excellent mechanical strength. The resulting device is called a sinter-bonded metal (SBM) flow restrictor. The manufacturing process creates a P/M structure with a vast number of random pathways for a gas to pass through. The resulting SBM restrictor acts as a highly precise calibrated leak when a vacuum is drawn through the outlet of the restrictor. The flow rate variance of the SBM restrictor 104 of the present invention is 1% in steady state and 1%-5% in non-steady state sampling conditions.

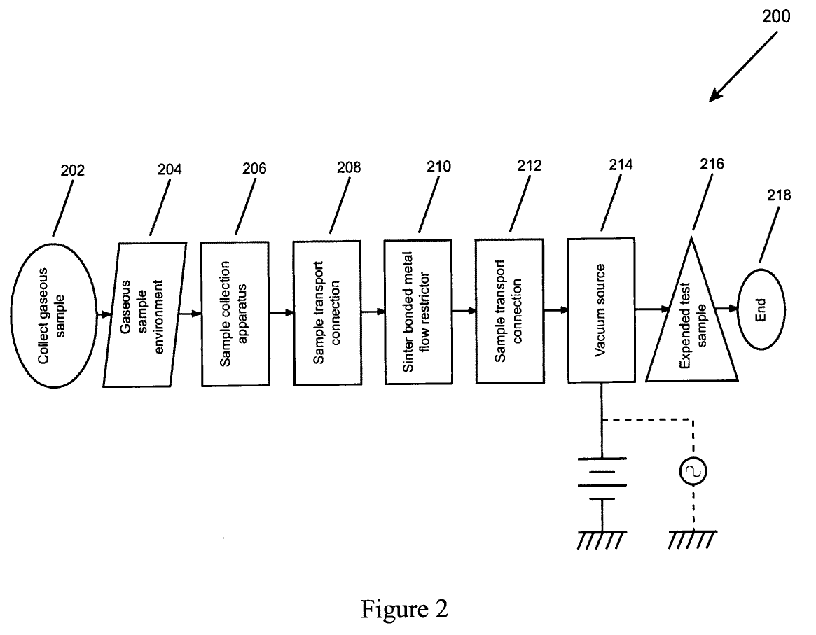

FIG. 2 shows a second representative embodiment of the present invention. This embodiment pertains to regulating volumetric gaseous flow at a specific rate for a specific duration of time. The volumetric flow rate multiplied by the duration comprises the total gaseous flow referred to as the gaseous sample. The physical connection between the sample collection apparatus and the sinter-bonded metal flow restrictor is made with flexible or rigid tubing. The tubing material must be of sufficient rigidity to minimize the effect of outside pressure on the volumetric gas flow rate drawn through the sample collection apparatus. The tubing inside diameter must be large enough to accommodate the required volumetric gaseous flow rate supplied by the sinter-bonded metal flow restrictor and chosen vacuum source. The connection between the tubing and other components is made with nut and ferrule compression fittings.

The sinter-bonded metal (SBM) flow restrictor 210 is the essential element in regulating volumetric gas flow through the sample collection apparatus 200. The SBM restrictor 210 provides a constant negative gas flow for a given set of pressure and temperature conditions in the gaseous sampling media. The restrictor is highly precise in regulating volumetric gas flow given a suitable stable vacuum source. The SBM restrictor 210 is custom manufactured based on specifications provided to the SBM restrictor manufacturer(s).

The required manufacturing specifications are derived from the sample collection apparatus 200 gas flow requirements, the negative pressure and flow supplied by the vacuum source 214, and the required accuracy in regulating volumetric gas flow provided to the sample collection apparatus 200. SBM manufacturers require manufacturing specifications in terms not readily applicable to low pressure drop, negative flow regimes specified in this invention. The SBM restrictor manufacturers require specifications in terms of positive flow in standard cubic centimeters per minute (SCCM) of pure Nitrogen gas at 30.0 pounds per square inch (psi).

A negative flow source or vacuum source 214 is specifically matched to the SBM restrictor 210 to regulate volumetric gas flow through the sample collection apparatus 206 of the sample collection apparatus 200. The vacuum source 214 can be supplied by a direct current (DC) vacuum pump if portability is desired or an alternating current (AC) vacuum pump connected to an appropriate power supply if large suction power is desired. The power supply can be any technology that provides sufficient electrical voltage and current to ensure the relatively stable operation of the vacuum source. Alternatively, but less feasible, a large evacuated chamber can provide the necessary negative pressure and sufficient negative flow rate for the effective operation of the SBM flow restrictor 210.

After traveling through the sample collection apparatus 206, associated sample tubing 208 and 212, SBM restrictor 210, and the vacuum source 214, the expended test sample 216 is exhausted back to the gaseous sample environment 204 or a sub-environment separate from the original gaseous sample environment 204.

The invention can operate between 0-95% relative humidity but not higher, because moisture condensation in the SBM restrictor 210 would adversely affect the restrictor's ability to accurately regulate volumetric gas flow through the restrictor 210.

The invention is designed and optimized to operate under a light vacuum (absolute pressure difference of −1.5 PSI to −3.5 PSI) to take advantage of the low pressure drop arrangement of the SBM restrictor 210. Operation of the invention under a deeper vacuum such as an absolute differential pressure that is greater than −3.5 PSI would require a vacuum pump drawing a substantial amount of operating current (i.e., power), this arrangement would negate a chief benefit of the invention; namely, the ability to operate in a low pressure drop environment. The invention is not designed to operate under positive pressure (>atmospheric pressure), a negative flow (i.e., vacuum) is a requisite for collecting aerosols with this invention.

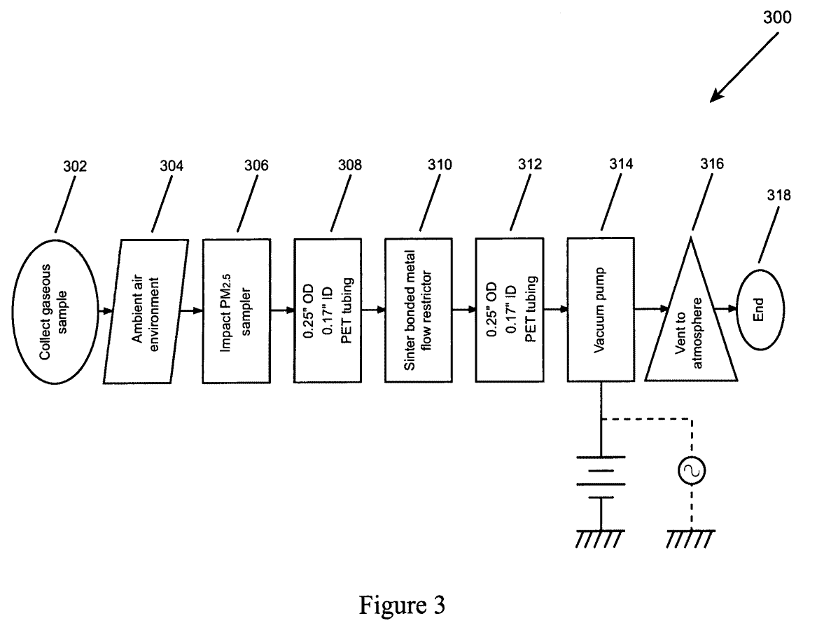

FIG. 3 is an embodiment of a sinter-bonded metal flow restrictor 310 regulating volumetric gas flow at 10 liters per minute for collecting airborne fine particulate matter with an impact sampler 306. This embodiment is designed to collect fine particulate aerosols (PM2.5) in the ambient air at 32° F. to 120° F. and with an altitude less than 20,000 ft above sea level.

Pertaining to impact sampler 306, particle-laden air from ambient air environment 304 enters the impact sampler 306 through a number of inlet nozzles. Larger particles are trapped by an impaction substrate while smaller ones follow the flow stream through an annular opening around the impaction substrate and are trapped by a filter. The particle-stripped air sample continues to flow through the polyethylene tubing 308. The impact sampler 306 operates at a flow rate of 10.0 liters per minute (LPM) and employs a 47 mm collection filter and 37 mm impaction substrate. Polyethylene (PET) tubing 308 having a 0.25″ outside diameter and a 0.17″ inside diameter is connected with nut and ferrule Nylon compression tube fittings to the impact sampler 306 on one end and the sinter-bonded metal flow restrictor 310 on the other end. The sinter-bonded metal (SBM) flow restrictor 310 is custom manufactured to regulate volumetric gas flow at 10.0 LPM given a 12.4 LPM vacuum flow at the 12 VDC vacuum pump. The SBM restrictor 310 is manufactured to a specification of 73,000 standard cubic centimeters per minute (SCCM) @ 30.0 psi Nitrogen gas.

By way of an example, a KNF Neuberger Inc. diaphragm vacuum pump operating on 12 VDC power is used to supply the required vacuum flow. The vacuum pump has a free flow of 12.4 LPM with the sampling components connected, i.e., without the SBM restrictor. The free-flow vacuum stream has an absolute pressure of 14.55 psi with a relative negative pressure equivalent to 4.4 inches of water with the sampling components connected. Coupled with the SBM restrictor 310 and the associated gas sampling components, a regulated volumetric gas flow of 10.0 LPM is achieved. This matching specification between the vacuum pump 314 and the restrictor 310 minimizes the amount of energy required to perform field sampling and allows the optimum use of the energy reserved in the battery, because the vacuum pump is operating at its optimum state at 10.0 LPM. The particle-stripped gas sample is vented to the atmosphere shown in 316 after passing through the impact sampler 306, the associated tubing 308 and 312, the SBM restrictor 310, and the diaphragm vacuum pump 314. In field use where a 12 Volt battery is unavailable, a 120 Volt AC source can be used to power a suitable vacuum pump.

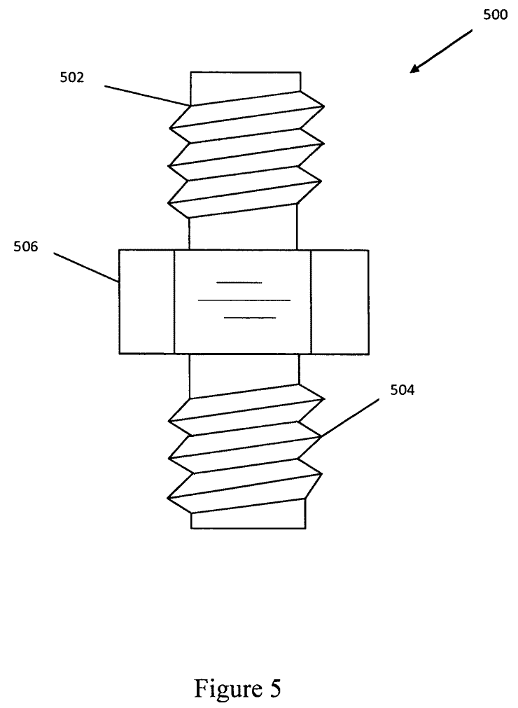

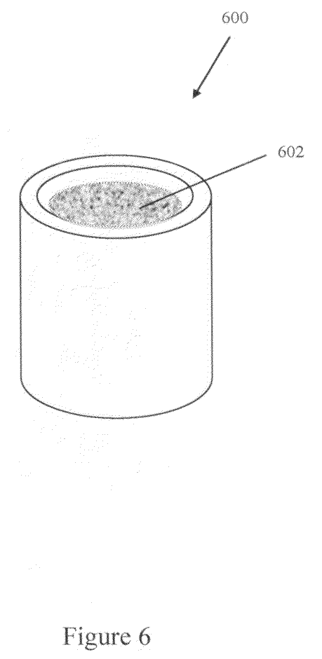

FIG. 5 shows a perspective view of an exterior housing of a finished sinter-bonded metal flow restrictor 500. The SBM element (from FIG. 6) is screwed on or press fit into a standard compression fitting. It has a first flow side 502 with coupling threads and a second flow side 504 also with coupling threads. Both the first flow side and the second flow side can be used to serve as either the flow input or flow output, the restrictor is radially and laterally symmetrical. In-between the first flow side 502 and the second flow side 504 is the body 506 of the restrictor housing with a hexagonal exterior surface to facilitate ease of coupling the restrictor housing with tubing by threads.

FIG. 6 shows a perspective view of a sinter-bonded metal flow restrictor 600. The SBM restrictor 600 is preferably constructed with sintered stainless steel particles 602. For this encapsulated restrictor element, it has an outside diameter of 0.25 inches, an outside height of 0.25 inches, an inside diameter of 0.173 inches and a sintered element height 0.15 inches. The present invention can operate with any type of sinter-bonded particles such as stainless steel, bronze, nickel, nickel-based alloys, titanium, aluminum, copper, platinum, gold, silver, niobium, tantalum, zirconium provided that the volumetric gas flow drawn through the inlet of the SBM restrictor is accurate and precise. The restrictor 600 requires no discrete power to operate, is chemically inert, can withstand temperatures up to several thousand degrees ° F. without melting, and is physically strong.

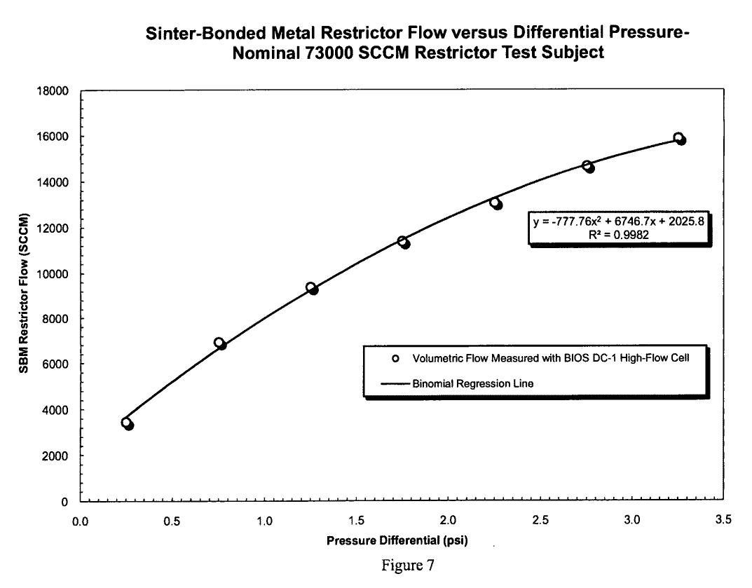

FIG. 7 shows a graph illustrating relationship between a Sinter-Bonded Metal Restrictor Flow versus Differential Pressure. A custom-manufactured sinter-bonded metal (SBM) flow restrictor was performance tested to demonstrate the highly predictable nature of the volumetric flow given fixed differential pressure as measured from the SBM restrictor inlet versus outlet. A nominal 73000 SCCM SBM restrictor was used for the test. In this test, a vacuum source was placed at the restrictor outlet along with a highly accurate absolute pressure gauge, and a flow measuring device was placed at the inlet of the restrictor along with a highly accurate absolute pressure gauge. FIG. 7 demonstrates the resulting SBM restrictor volumetric flow rate when a given differential pressure is applied to the outlet of the SBM restrictor. The binomial regression line demonstrates the high degree of correlation (R2=0.9982) between differential pressure and resulting volumetric flow. The highly predictable nature of carefully designed and manufactured SBM restrictors make them ideal for low pressure drop configurations as cited in the invention.

1. A pollution sampling device, comprising
an inertial impactor;
a sinter-bonded metal flow restrictor;
a vacuum pump; and
a power supply;
wherein the inertial impactor, the sinter-bonded metal flow restrictor and the vacuum pump are connected in respective order to establish a channel of fluid communication there-through; and
wherein the power source energies the vacuum pump to generate a negative pressure in the channel of fluid communication.

2. The pollution sampling device of claim 1, wherein the inertial impactor comprises at least one air filter.

3. The pollution sampling device of claim 1, wherein the inertial impactor comprises at least one collection plate.

4. The pollution sampling device of claim 3, wherein the inertial impactor comprises at least one viscous layer on the collection plate.

5. The pollution sampling device of claim 1, wherein the inertial impactor has one of a specification of PM1.0, PM2.5, PM10, and PM coarse (7.5 um-10.0 um).

6. The pollution sampling device of claim 1, wherein the inertial impactor comprises at least one nozzle for fluid or particulate matter intake.

7. The pollution sampling device of claim 1, wherein the sinter-bonded metal flow restrictor is insertably installed into a restrictor housing with a threaded input side, a threaded output side, and an exterior mid-portion resembling a hex-nut suitable for coupling a wrench for fastening.

8. The pollution sampling device of claim 7, wherein the first tubing and the second tubing each has an interior diameter of 0.17 inch and an exterior diameter of 0.25 inch.

9. The pollution sampling device of claim 1, wherein the inertial impactor is connected to the threaded input side of the restrictor housing by a first tubing and the threaded output side of the restrictor housing is connected to an input of the vacuum pump by a second tubing.

10. The pollution sampling device of claim 1, wherein the sinter-bonded metal flow restrictor is manufactured with one of stainless steel, bronze, nickel, nickel-based alloys, titanium, aluminum, copper, platinum, gold, silver, niobium, tantalum, zirconium to achieve a pre-determined volumetric flow rate.

11. The pollution sampling device of claim 1, wherein a flow tolerance level of the sinter-bonded metal flow restrictor is in a range between 1% and 5%.

12. The pollution sampling device of claim 10, wherein the predetermined volumetric flow rate of the sinter-bonded metal flow restrictor is 10 liters per minute.

13. The pollution sampling device of claim 1, wherein the sinter-bonded metal flow restrictor has a specification of 73,000 standard cubic centimeters per minute flow rate at 30 pounds per square inch of Nitrogen gas.

14. The pollution sampling device of claim 1, wherein the vacuum pump has a free flow rate of 12.4 liters per minute.

15. The pollution sampling device of claim 1, wherein the vacuum pump provides a free flow vacuum stream of an absolute pressure of 14.55 pounds per square inch with a negative pressure equivalent to 4.4 inches of water.

16. The pollution sampling device of claim 1, wherein the power supply provides substantially 120 VAC.

17. The pollution sampling device of claim 1, wherein the power supply is a battery providing substantially 12 VDC.

18. The pollution sampling device of claim 1, wherein the device is designed to collect particulate matter PM2.5 in the ambient air environment between 32° F. to 120° F. with an altitude less than 20,000 feet above sea level.

19. The pollution sampling device of claim 1, wherein the device is portable and capable to be easily hand carried to a field testing site by an operator.

20. The pollution sampling device of claim 1, wherein an output flow of the vacuum pump is discharged to one of an ambient atmosphere and a controlled sub-environment.
